(19) United States
(12) Patent Application Publication
(10) Pub. No.: US 2024/0306129 A1
(43) Pub. Date: Sep. 12, 2024

(54) METHOD AND APPARATUS FOR CONFIGURING AND DETERMINING DOWNLINK SCHEDULING INFORMATION, DEVICE, AND MEDIUM

(71) Applicant: BEIJING XIAOMI MOBILE SOFTWARE CO., LTD., Beijing (CN)

(72) Inventor: Ting FU, Beijing (CN)

(73) Assignee: BEIJING XIAOMI MOBILE SOFTWARE CO., LTD., Beijing (CN)

(21) Appl. No.: 18/281,546

(22) PCT Filed: Mar. 10, 2023
(86) PCT No.: PCT/CN2021/080059

§ 371 Date: Sep. 11, 2023

(51) Int. Cl. H04W 72/0446; H04W 72/232

(52) U.S. Cl. CPC H04W 72/0446; H04W 72/232

(57) ABSTRACT

The present disclosure provides a method and an apparatus for configuring and determining downlink scheduling information, a device, and a medium, applied to the technical field of wireless communication. The method for configuring downlink scheduling information includes: setting a k0 set of DCI in a multi-slot PDCCH monitoring span to contain at least one negative integer less than 0 in the k0 set, the k0 set including at least one k0, the k0 being an interval between a time slot where the DCI in the multi-slot PDCCH monitoring span is located and a time slot where PDSCH scheduled by the DCI is located, and the at least one k0 including the at least one negative integer less than 0.

### CROSS REFERENCE TO RELATED APPLICATION

The present disclosure is the U.S. national phase application of International Application No. PCT/CN2021/080059 filed on Mar. 10, 2021, the content of which is incorporated herein by reference in its entirety for all purposes.

### TECHNICAL FIELD

The present disclosure relates to the field of wireless communication technology, in particular to a method and an apparatus for configuring and determining downlink scheduling information, a device, and a medium.

### BACKGROUND

In the New Radio (NR) protocol, downlink data is carried on the Physical Downlink Shared Channel (PDSCH), and uplink data is carried on the Physical Uplink Shared Channel (PUSCH). A base station schedules PDSCH and PUSCH through Downlink Control Information (DCI) carried on the Physical Downlink Control Channel (PDCCH).

The PDCCH includes Common Search Space (CSS) and User Equipment Specific Search Space (USS) for the user equipment (UE). The CSS is used to carry cell public control information, multicast control information, etc., and can also be used to carry UE specific control information. The USS is used to carry the UE specific control information.

### SUMMARY

According to a first aspect, a method for configuring downlink scheduling information is provided. The method is performed by a network side device, and includes setting a k0 set of DCI in a multi-slot PDCCH monitoring span, wherein the k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0.

According to a second aspect, a method for determining downlink scheduling information is provided. The method is performed by user equipment, and includes determining a k0 set of DCI in a multi-slot PDCCH monitoring span, wherein the k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0; determining a k0 corresponding to each DCI in the multi-slot PDCCH monitoring span; and determining a time-frequency resource for PDSCH scheduled by each DCI based on the k0 corresponding to each DCI.

According to a third aspect, an apparatus for configuring downlink scheduling information is provided. The apparatus is applied to a network side device, and includes a setting module configured to set a k0 set of DCI in a multi-slot PDCCH monitoring span, wherein the k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0.

According to a fourth aspect, an apparatus for determining downlink scheduling information is provided. The apparatus is applied to user equipment, and includes a first determination module configured to determine a k0 set of DCI in a multi-slot PDCCH monitoring span, wherein the k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0; a second determination module configured to determine a k0 corresponding to each DCI in the multi-slot PDCCH monitoring span; and a third determination module configured to determine a time-frequency resource for PDSCH scheduled by each DCI based on the k0 corresponding to each DCI.

According to a fifth aspect, a network side device is provided. The network side device includes a processor, and a memory configured to store instructions executable by the processor, wherein the processor is configured to execute the instructions in the memory to implement steps of the method for configuring downlink scheduling information.

According to a sixth aspect, user equipment is provided. The user equipment includes a processor, and a memory configured to store instructions executable by the processor, wherein the processor is configured to execute the instructions in the memory to implement steps of the method for determining downlink scheduling information.

According to a seventh aspect, a non-temporary computer-readable storage medium is provided. The non-temporary computer-readable storage medium has executable instructions stored thereon, which when executed by a processor, cause the method for configuring downlink scheduling information or the method for determining downlink scheduling information to be implemented.

It should be understood that the general description above and the detailed description in the following are only illustrative and explanatory, and do not limit the present disclosure.

### BRIEF DESCRIPTION OF THE DRAWINGS

The drawings illustrated herein are intended to provide a further understanding of embodiments and constitute a part of the present disclosure. The drawings and their explanations are used to explain embodiments of the present disclosure and do not constitute an improper limitation of the embodiments of the present disclosure, in which:

FIG. 1 is a schematic diagram of DCI scheduling for multi-slot span PDCCH monitoring according to exemplary embodiments;

FIG. 2 is a schematic diagram of DCI scheduling for multi-slot span PDCCH monitoring according to exemplary embodiments;

FIG. 3 is a flowchart of a method for configuring downlink control information, applied to a network side device, according to exemplary embodiments;

FIG. 4 is a flowchart of a method for configuring downlink control information, applied to a network side device, according to exemplary embodiments;

FIG. 5 is a schematic diagram of DCI scheduling for multi-slot span PDCCH monitoring according to exemplary embodiments;

FIG. 6 is a schematic diagram of DCI scheduling for multi-slot span PDCCH monitoring according to exemplary embodiments;

FIG. 7 is a flowchart of a method for configuring downlink control information, applied to a network side device, according to exemplary embodiments;

FIG. 8 is a schematic diagram of DCI scheduling for multi-slot span PDCCH monitoring according to exemplary embodiments;

FIG. 9 is a flowchart of a method for configuring downlink control information, applied to a network side device, according to exemplary embodiments;

FIG. 10 is a flowchart of a method for determining downlink control information, applied to user equipment, according to exemplary embodiments;

FIG. 11 is a structural diagram of an apparatus for configuring downlink control information, applied to a network side device, according to exemplary embodiments;

FIG. 12 is a structural diagram of an apparatus for determining downlink control information, applied to user equipment, according to exemplary embodiments;

FIG. 13 is a block diagram of a device for configuring downlink control information according to exemplary embodiments;

FIG. 14 is a block diagram of a device for determining downlink control information according to exemplary embodiments.

### DETAILED DESCRIPTION

Embodiments of the present disclosure will be further explained in conjunction with the drawings and exemplary implementations.

Exemplary embodiments will be explained in detail herein, with examples illustrated in the drawings. When the following description refers to the drawings, the same numerals in different drawings, unless otherwise indicated, represent the same or similar elements. Implementations described in the following exemplary embodiments do not represent all embodiments that are consistent with embodiments of the present disclosure. They are rather only examples of apparatuses and methods that are consistent with some aspects of the present disclosure as detailed in the appended claims.

Within a high-frequency band (for example, around 60 GHZ), in order to cope with phase noise, it is usually selected to use a larger subcarrier bandwidth, for example, 960 KHz. A larger subcarrier bandwidth corresponds to a smaller duration (in which case the duration is a duration of a time slot). When the subcarrier bandwidth is 960 KHz, the corresponding duration of one time slot is 1/64 milliseconds (ms). Within such shorter duration, user equipment may not be able to perform monitoring for the PDCCH channel on each time slot. In some embodiments, a span PDCCH monitoring pattern, also known as a multi-slot span PDCCH monitoring pattern, can be introduced. In this multi-slot span PDCCH monitoring mode, a multi-slot PDCCH monitoring span includes more than one time slot, and a DCI monitoring capability of user equipment within the span is defined in the unit of a span.

In one multi-slot PDCCH monitoring span, there may be multiple time slots used to carry DCI. The time slot used to carry DCI herein is referred to as a PDCCH time slot, and the one multi-slot PDCCH monitoring span may include multiple PDCCH time slots.

In the R15 protocol, a monitoring capability is defined based on a single time slot as a time unit. Specifically, the monitoring capability of UE within each time slot is specified based on the difference in subcarrier spacing (SCS). The monitoring capability of UE within a time slot includes a maximum number of monitoring times within the slot and a maximum number of non-overlapping control channel elements (CCE) within the slot. This definition applies to frequencies below 52.6 GHz, with optional subcarrier bandwidths of 15 KHz, 30 KHz, 60 KHz, or 120 KHz. The duration of the time slot varies depending on the subcarrier bandwidth. For example, the duration of the time slot corresponding to a subcarrier bandwidth of 15 KHz is 1 millisecond (ms), the duration of the time slot corresponding to a subcarrier bandwidth of 30 KHz is 0.5 ms, the duration of the time slot corresponding to a subcarrier bandwidth of 60 KHz is 0.25 ms, and so on. As the subcarrier bandwidth increases, the duration of the time slot decreases.

In the R15 or R16 protocol, it is necessary for DCI to indicate an interval k0 (in the unit of a time slot) between a time slot where the DCI is located and a time slot where the PDSCH to be scheduled by the DCI is located. In the current protocol, a value range of k0 is {0, 32}, and k0 is an integer between 0 and 32. By setting k0 to be zero or a positive integer, it ensures that the time slot where the PDSCH is located does not go ahead of the time slot where the DCI scheduling the PDSCH is located.

It is possible to flexibly select, through DCI, resources for carrying information within a range determined based on the monitoring capability of UE, to avoid resource collisions. In order to achieve flexible PDSCH scheduling, it may occur that an appropriate PDSCH resource to be scheduled by DCI goes ahead of a time slot where the DCI is located.

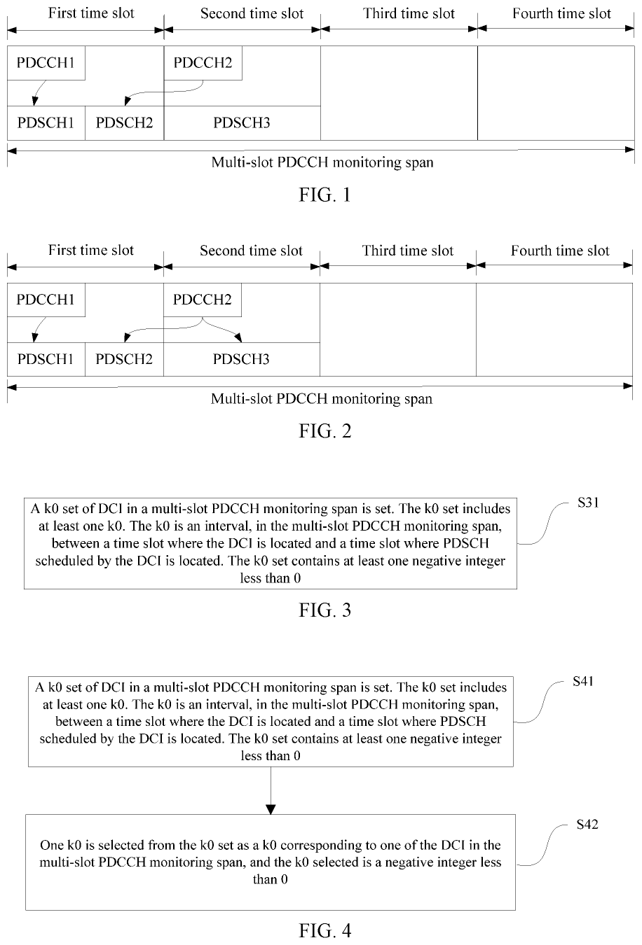

For example, as shown in FIG. 1, the multi-slot PDCCH monitoring span includes four time slots, which include a first time slot, a second time slot, a third time slot, and a fourth time slot.

The first time slot corresponds to PDCCH1, PDSCH1, and PDSCH2.

The second time slot corresponds to PDCCH2 and PDSCH3.

A time slot corresponding to the DCI is the second time slot, and an object scheduled by this DCI is PDSCH2, that is, a time slot where the PDSCH2 scheduled by this DCI is located (i.e. the first time slot) goes ahead of a time slot where this DCI is located (i.e. the second time slot).

For example, as shown in FIG. 2, the multi-slot PDCCH monitoring span includes four time slots, which include a first time slot, a second time slot, a third time slot, and a fourth time slot.

The first time slot corresponds to PDCCH1, PDSCH1, and PDSCH2.

The second time slot corresponds to PDCCH2 and PDSCH3.

A time slot corresponding to the DCI is the second time slot, and objects scheduled by this DCI are PDSCH2 and PDSCH3, that is, a time slot where the PDSCH2 among all PDSCHs scheduled by this DCI is located (i.e. the first time slot) goes ahead of a time slot where this DCI is located (i.e. the second time slot).

In order to achieve flexible scheduling and to enable DCI to schedule PDSCH resources located ahead of a time slot where this DCI is located, embodiments of the present disclosure provide a method for configuring downlink scheduling information, which is performed by a network side device. The network side device can be a base station device. Referring to FIG. 3, a flowchart of a method for configuring downlink control information according to exemplary embodiments is provided, and as shown in FIG. 3, the method includes following steps.

In step S31, a k0 set of DCI in a multi-slot PDCCH monitoring span is set. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0.

In embodiments of the present disclosure, by setting the k0 set to contain the negative integer less than 0, the DCI is enabled to schedule PDSCH resources located ahead of the time slot where this DCI is located, so as to make full use of PDSCH resources and achieve flexible scheduling.

Embodiments of the present disclosure provide a method for configuring downlink scheduling information, which is performed by a network side device, and the method includes following steps.

A high-level signaling is sent, and the high-level signaling includes the k0 set of the DCI in the multi-slot PDCCH monitoring span. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0.

In embodiments of the present disclosure, the k0 set is set to contain the negative integer less than 0, and the high-level signaling is sent, with the k0 set of the DCI in the multi-slot PDCCH monitoring span carried in the high-level signaling. As a result, the k0 set of the DCI in the multi-slot PDCCH monitoring span is clearly indicated to the user equipment, so that the user equipment can know this k0 set and use it appropriately.

Embodiments of the present disclosure provide a method for configuring downlink scheduling information, which is performed by a network side device, and the method includes following steps.

A k0 set of DCI in a multi-slot PDCCH monitoring span is set. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0. The k0 set contains all values between 1-Y and −1, and Y is the number of PDCCH time slots included in the multi-slot PDCCH monitoring span.

In embodiments of the present disclosure, all values between 1-Y and −1 are set to be contained in the k0 set, so that negative integers less than 0 contained in the k0 set correspond to a time slot coverage capability of the multi-slot PDCCH monitoring span, and values of the negative integers less than 0 contained in the k0 set are reasonable values.

Embodiments of the present disclosure provide a method for configuring downlink scheduling information, which is performed by a network side device, and the method includes following steps.

A k0 set of DCI in a multi-slot PDCCH monitoring span is set. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0. The k0 set contains part of values between 1-Y and −1, and Y is the number of PDCCH time slots included in the multi-slot PDCCH monitoring span.

In embodiments of the present disclosure, part of values between 1-Y and −1 are set to be contained in the k0 set, so that negative integers less than 0 contained in the k0 set correspond to a time slot coverage capability of the multi-slot PDCCH monitoring span, and values of the negative integers less than 0 contained in the k0 set are reasonable values.

Embodiments of the present disclosure provide a method for configuring downlink scheduling information, which is performed by a network side device, and the method includes following steps.

A high-level signaling is sent, and the high-level signaling includes the k0 set of the DCI in the multi-slot PDCCH monitoring span. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0. The k0 set contains all or part of values between 1-Y and −1, and Y is the number of PDCCH time slots included in the multi-slot PDCCH monitoring span.

In embodiments of the present disclosure, all or part of values between 1-Y and −1 are set to be contained in the k0 set, so that negative integers less than 0 contained in the k0 set correspond to a time slot coverage capability of the multi-slot PDCCH monitoring span, and values of the negative integers less than 0 contained in the k0 set are reasonable values. The high-level signaling is sent, with the k0 set of the DCI in the multi-slot PDCCH monitoring span carried in the high-level signaling, so that the k0 set of the DCI in the multi-slot PDCCH monitoring span is clearly indicated to the user equipment, and so that the user equipment can know this k0 set and use it appropriately.

Embodiments of the present disclosure provide a method for configuring downlink scheduling information, which is performed by a network side device. The network side device can be a base station device. Referring to FIG. 4, a flowchart of a method for configuring downlink control information according to exemplary embodiments is provided, and as shown in FIG. 4, the method includes following steps.

In step S41, a k0 set of DCI in a multi-slot PDCCH monitoring span is set. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0.

In step S42, one k0 is selected from the k0 set as a k0 corresponding to one of the DCI in the multi-slot PDCCH monitoring span, and the k0 selected is a negative integer less than 0.

In some embodiment, the method further includes following steps.

In step S43, the DCI in the multi-slot PDCCH monitoring span is sent, and the DCI includes the k0 corresponding to the DCI.

In embodiments of the present disclosure, the k0 set is set to contain the negative integer less than 0, and when setting the k0 corresponding to the DCI, a negative integer less than 0 can be selected from the k0 set containing the negative integer less than 0 as the k0 corresponding to the DCI. As a result, the DCI is enabled to schedule PDSCH resources located ahead of the time slot where this DCI is located, so as to make full use of PDSCH resources and achieve flexible scheduling.

In some embodiments, the k0 set includes all or part of values between 1-Y and −1, and Y is the number of PDCCH time slots included in the multi-slot PDCCH monitoring span, so that negative integers less than 0 contained in the k0 set correspond to a time slot coverage capability of the multi-slot PDCCH monitoring span, and so that the value of the negative integer less than 0 selected from the k0 set is a reasonable value.

In some embodiments, the k0 set having been set contains the negative integer less than 0, which may lead to an increase in buffer overhead of the user equipment. For example, after the k0 set has been set to contain the negative integer less than 0, for one multi-slot PDCCH monitoring span, the user equipment may need to buffer relevant data starting from a time slot corresponding to the negative integer which is located ahead of the multi-slot PDCCH monitoring span.

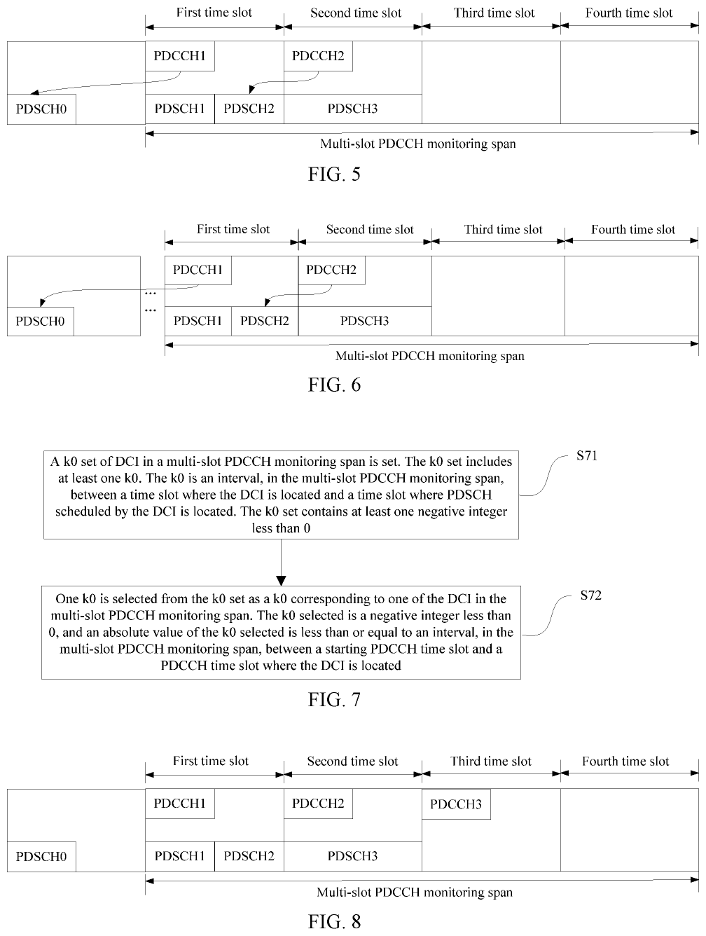

For example, as shown in FIG. 5, the multi-slot PDCCH monitoring span includes four time slots, which include a first time slot, a second time slot, a third time slot, and a fourth time slot. A time slot ahead of the first time slot (which can be referred to as a 0th time slot) corresponds to PDSCH0. The first time slot corresponds to PDCCH1, PDSCH1, and PDSCH2. The second time slot corresponds to PDCCH2 and PDSCH3. A time slot where a first DCI is located is the first time slot, and the first DCI schedules the PDSCH0. The PDSCH0 is located in the 0^{th} time slot ahead of and adjacent to the first time slot, making it possible for the user equipment to buffer relevant data for the multi-slot PDCCH monitoring span starting from the 0^{th} time slot.

For example, as shown in FIG. 6, the multi-slot PDCCH monitoring span includes four time slots, which include a first time slot, a second time slot, a third time slot, and a fourth time slot. When the PDSCH0 is located in a K^{th} time slot ahead of the first time slot, it is possible for the user equipment to buffer relevant data for the multi-slot PDCCH monitoring span starting from the K^{th} time slot ahead of the first time slot. K is a positive integer, and the larger the value of K is, the greater the buffer overhead of the user equipment is.

In order to reduce the buffer overhead of the user equipment, it is necessary to limit the resource location of PDSCH scheduled by the DCI in the multi-slot PDCCH monitoring span. Embodiments of the present disclosure provide a method for configuring downlink scheduling information, which is performed by a network side device. The network side device can be a base station device. Referring to FIG. 7, a flowchart of a method for configuring downlink control information according to exemplary embodiments is provided, and as shown in FIG. 7, the method includes following steps.

In step S71, a k0 set of DCI in a multi-slot PDCCH monitoring span is set. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0.

In step S72, one k0 is selected from the k0 set as a k0 corresponding to one of the DCI in the multi-slot PDCCH monitoring span. The k0 selected is a negative integer less than 0, and an absolute value of the k0 selected is less than or equal to an interval between a starting PDCCH time slot in the multi-slot PDCCH monitoring span and a PDCCH time slot where the DCI in the multi-slot PDCCH monitoring span is located.

In embodiments of the present disclosure, by limiting the absolute value of the k0 selected to be not greater than the interval between the starting PDCCH time slot in the multi-slot PDCCH monitoring span and the PDCCH time slot where the DCI in the multi-slot PDCCH monitoring span is located, the PDSCH scheduled by the DCI in the multi-slot PDCCH monitoring span is restricted to be not ahead of the starting time slot in the multi-slot PDCCH monitoring span. As a result, it ensures, even if k0 is negative, that the user equipment starts buffering from the starting time slot in the multi-slot PDCCH monitoring span, without resulting in any increase in the buffer overhead of the user equipment due to configuration of the negative value in the k0 set.

In some embodiments, as shown in FIG. 8, the multi-slot PDCCH monitoring span includes four time slots, which include a first time slot, a second time slot, a third time slot, and a fourth time slot. A time slot ahead of the first time slot (which is referred to as a 0^{th} time slot) corresponds to PDSCH0. The first time slot corresponds to PDCCH1, PDSCH1, and PDSCH2. The second time slot corresponds to PDCCH2 and PDSCH3. The third time slot corresponds to PDCCH3.

A time slot where a first DCI is located is the first time slot. Under the constraint that the absolute value of k0 corresponding to the first DCI needs to be less than or equal to the interval between the starting PDCCH time slot in the multi-slot PDCCH monitoring span and the PDCCH time slot where the DCI in the multi-slot PDCCH monitoring span is located, the value of k0 corresponding to the first DCI can be only a value greater than or equal to 0.

A time slot where a second DCI is located is the second time slot. Under the constraint that the absolute value of k0 corresponding to the second DCI needs to be less than or equal to the interval between the starting PDCCH time slot in the multi-slot PDCCH monitoring span and the PDCCH time slot where the DCI in the multi-slot PDCCH monitoring span is located, the value of k0 corresponding to the second DCI can be set as −1 or a value greater than or equal to 0.

A time slot where a third DCI is located is the third time slot. Under the constraint that the absolute value of k0 corresponding to the third DCI needs to be less than or equal to the interval between the starting PDCCH time slot in the multi-slot PDCCH monitoring span and the PDCCH time slot where the DCI in the multi-slot PDCCH monitoring span is located, the value of k0 corresponding to the third DCI can be set as −2, −1, or a value greater than or equal to 0.

Embodiments of the present disclosure provide a method for configuring downlink scheduling information, which is performed by a network side device. The network side device can be a base station device. Referring to FIG. 9, a flowchart of a method for configuring downlink control information according to exemplary embodiments is provided, and as shown in FIG. 9, the method includes following steps.

In step S91, a k0 set of DCI in a multi-slot PDCCH monitoring span is set. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0.

In step S92, one k0 is selected from the k0 set as a k0 corresponding to one of the DCI in the multi-slot PDCCH monitoring span. The k0 selected is a negative integer less than 0, and an absolute value of the k0 selected is less than or equal to an interval between a starting PDCCH time slot in the multi-slot PDCCH monitoring span and a PDCCH time slot where the DCI in the multi-slot PDCCH monitoring span is located.

In step S93, the DCI in the multi-slot PDCCH monitoring span is sent, and the DCI includes the k0 corresponding to the DCI.

In embodiments of the present disclosure, by limiting the absolute value of the k0 selected to be less than or equal to the interval between the starting PDCCH time slot in the multi-slot PDCCH monitoring span and the PDCCH time slot where the DCI in the multi-slot PDCCH monitoring span is located, the PDSCH scheduled by the DCI in the multi-slot PDCCH monitoring span is restricted to be not ahead of the starting time slot in the multi-slot PDCCH monitoring span, thereby achieving flexible scheduling while reducing the buffer overhead of the user equipment.

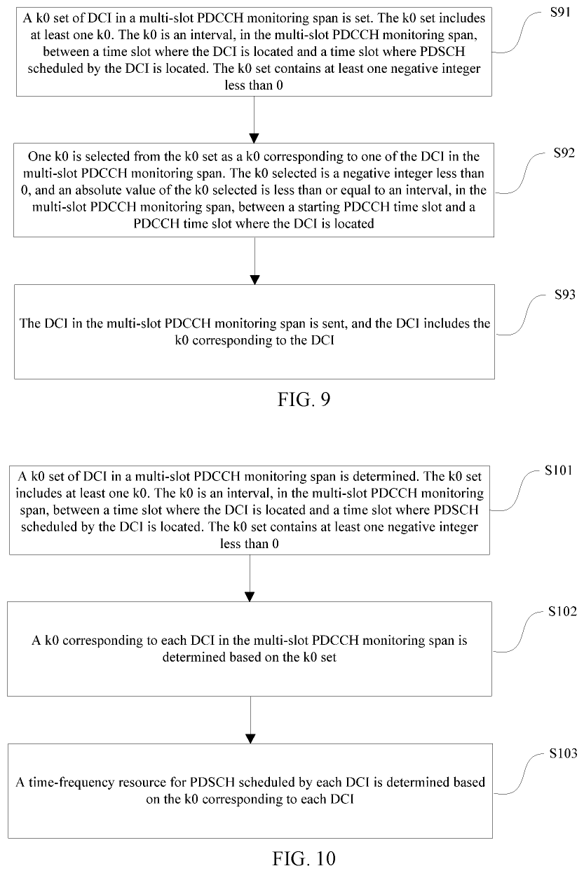

Embodiments of the present disclosure provide a method for determining downlink scheduling information, which is performed by user equipment. Referring to FIG. 10, a flowchart of a method for determining downlink control information according to exemplary embodiments is provided, and as shown in FIG. 10, the method includes following steps.

In step S101, a k0 set of DCI in a multi-slot PDCCH monitoring span is determined. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0.

In step S102, a k0 corresponding to each DCI in the multi-slot PDCCH monitoring span is determined based on the k0 set.

In step S103, a time-frequency resource for PDSCH scheduled by each DCI is determined based on the k0 corresponding to each DCI.

Embodiments of the present disclosure provide a method for determining downlink scheduling information, which is performed by user equipment, and the method includes following steps.

In some embodiments, a high-level signaling is received, and the high-level signaling includes the k0 set of the DCI in the multi-slot PDCCH monitoring span. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0.

In some embodiments, a k0 corresponding to each DCI in the multi-slot PDCCH monitoring span is determined based on the k0 set.

In some embodiments, a time-frequency resource for the PDSCH scheduled by each DCI is determined based on the k0 corresponding to each DCI.

Embodiments of the present disclosure provide a method for determining downlink scheduling information, which is performed by user equipment, and the method includes following steps.

In some embodiments, a k0 set of DCI in a multi-slot PDCCH monitoring span is determined. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0. The k0 set contains all or part of values between 1-Y and −1, and Y is the number of PDCCH time slots included in the multi-slot PDCCH monitoring span.

In some embodiments, a k0 corresponding to each DCI in the multi-slot PDCCH monitoring span is determined based on the k0 set.

In some embodiments, a time-frequency resource for the PDSCH scheduled by each DCI is determined based on the k0 corresponding to each DCI.

Embodiments of the present disclosure provide a method for determining downlink scheduling information, which is performed by user equipment, and the method includes following steps.

In some embodiments, a k0 set of DCI in a multi-slot PDCCH monitoring span is determined. The k0 set includes at least one k0. The k0 is an interval between a time slot where the DCI in the multi-slot PDCCH monitoring span is located and a time slot where PDSCH scheduled by the DCI is located. The k0 set contains at least one negative integer less than 0. The k0 set contains all or part of values between 1-Y and −1, and Y is the number of PDCCH time slots included in the multi-slot PDCCH monitoring span.

In some embodiments, a k0 corresponding to each DCI in the multi-slot PDCCH monitoring span is determined based on the k0 set, an absolute value of the k0 is less than or equal to an interval between a starting PDCCH time slot in the multi-slot PDCCH monitoring span and a PDCCH time slot where the DCI in the multi-slot PDCCH monitoring span is located.

In some embodiments, a time-frequency resource for the PDSCH scheduled by each DCI is determined based on the k0 corresponding to each DCI.

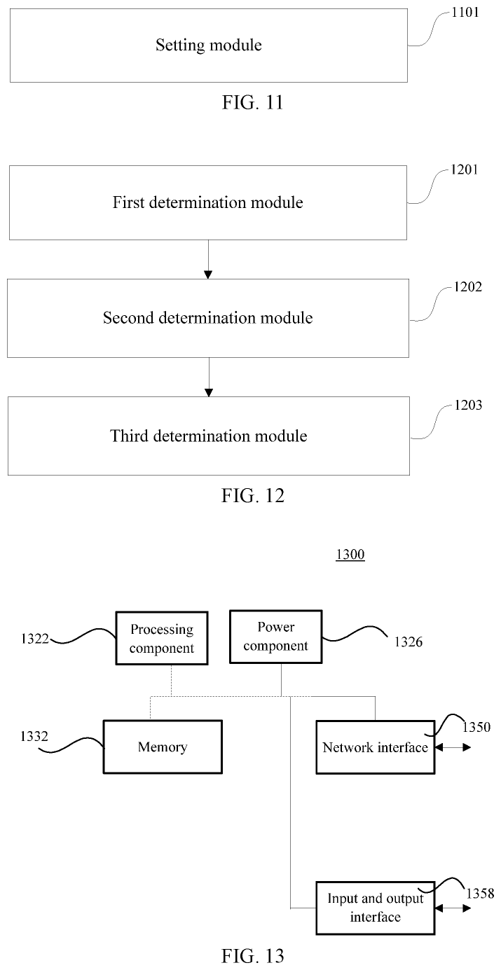

Embodiments of the present disclosure provide an apparatus for configuring downlink scheduling information, which is applied to a network side device. Referring to FIG. 11, a structural diagram of an apparatus for configuring downlink control information according to exemplary embodiments is provided, and as shown in FIG. 11, the apparatus includes a setting module 1101.

The setting module 1101 to set a k0 set of DCI in a multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0.

Embodiments of the present disclosure provide an apparatus for configuring downlink scheduling information, which is applied to a network side device, and the apparatus includes a first sending module.

The first sending module is configured to send a high-level signaling, and the high-level signaling includes the k0 set of the DCI in the multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0.

Embodiments of the present disclosure provide an apparatus for configuring downlink scheduling information, which is applied to a network side device, and the apparatus includes a setting module.

The setting module is configured to set a k0 set of DCI in a multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0. The k0 set contains all values between 1-Y and −1, and Y is the number of PDCCH time slots included in the multi-slot PDCCH monitoring span.

Embodiments of the present disclosure provide an apparatus for configuring downlink scheduling information, which is applied to a network side device, and the apparatus includes a setting module.

The setting module is configured to set a k0 set of DCI in a multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0. The k0 set contains part of values between 1-Y and −1, and Y is the number of PDCCH time slots included in the multi-slot PDCCH monitoring span.

Embodiments of the present disclosure provide an apparatus for configuring downlink scheduling information, which is applied to a network side device, and the apparatus includes a setting module and a selection module.

The setting module is configured to set a k0 set of DCI in a multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0.

The selection module is configured to select one k0 from the k0 set as a k0 corresponding to one of the DCI in the multi-slot PDCCH monitoring span. The k0 selected is a negative integer less than 0.

Embodiments of the present disclosure provide an apparatus for configuring downlink scheduling information, which is applied to a network side device, and the apparatus includes a setting module and a selection module.

The setting module is configured to set a k0 set of DCI in a multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0.

The selection module is configured to select one k0 from the k0 set as a k0 corresponding to one of the DCI in the multi-slot PDCCH monitoring span. The k0 selected is a negative integer less than 0, and an absolute value of the k0 selected is less than or equal to an interval between a starting PDCCH time slot in the multi-slot PDCCH monitoring span and a PDCCH time slot where the DCI in the multi-slot PDCCH monitoring span is located.

Embodiments of the present disclosure provide an apparatus for configuring downlink scheduling information, which is applied to a network side device, and the apparatus includes a setting module, a selection module and a second sending module.

The setting module is configured to set a k0 set of DCI in a multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0.

The selection module is configured to select one k0 from the k0 set as a k0 corresponding to one of the DCI in the multi-slot PDCCH monitoring span. The k0 selected is a negative integer less than 0, and an absolute value of the k0 selected is less than or equal to an interval between a starting PDCCH time slot in the multi-slot PDCCH monitoring span and a PDCCH time slot where the DCI in the multi-slot PDCCH monitoring span is located.

The second sending module is configured to send the DCI in the multi-slot PDCCH monitoring span. The DCI includes the k0 corresponding to the DCI.

Embodiments of the present disclosure provide an apparatus for determining downlink scheduling information, which is applied to user equipment. Referring to FIG. 12, a structural diagram of an apparatus for determining downlink control information according to exemplary embodiments is provided, and as shown in FIG. 12, the apparatus includes a first determination module 1201, a second determination module 1202, and a third determination module 1203.

The first determination module 1201 is configured to determine a k0 set of DCI in a multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0.

The second determination module 1202 is configured to determine a k0 corresponding to each DCI in the multi-slot PDCCH monitoring span.

The third determination module 1203 is configured to determine a time-frequency resource for PDSCH scheduled by each DCI based on the k0 corresponding to each DCI.

Embodiments of the present disclosure provide an apparatus for determining downlink scheduling information, which is applied to user equipment, and the apparatus includes a receiving module, a second determination module, and a third determination module.

The receiving module is configured to receive a high-level signaling including the k0 set of the DCI in the multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0.

The second determination module is configured to determine a k0 corresponding to each DCI in the multi-slot PDCCH monitoring span.

The third determination module is configured to determine a time-frequency resource for PDSCH scheduled by each DCI based on the k0 corresponding to each DCI.

Embodiments of the present disclosure provide an apparatus for determining downlink scheduling information, which is applied to user equipment, and the apparatus includes a first determination module, a second determination module, and a third determination module.

The first determination module is configured to determine a k0 set of DCI in a multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0. The k0 set contains all or part of values between 1-Y and −1, and Y is a number of PDCCH time slots included in the multi-slot PDCCH monitoring span.

The second determination module is configured to determine a k0 corresponding to each DCI in the multi-slot PDCCH monitoring span.

The third determination module is configured to determine a time-frequency resource for PDSCH scheduled by each DCI based on the k0 corresponding to each DCI.

Embodiments of the present disclosure provide an apparatus for determining downlink scheduling information, which is applied to user equipment, and the apparatus includes a first determination module, a second determination module, and a third determination module.

The first determination module is configured to determine a k0 set of DCI in a multi-slot PDCCH monitoring span. The k0 set includes at least one k0, the k0 is an interval between a time slot where the DCI in the multi-slot PDCCH monitoring span is located and a time slot where PDSCH scheduled by the DCI is located, and the k0 set contains at least one negative integer less than 0.

The second determination module is configured to determine a k0 corresponding to each DCI in the multi-slot PDCCH monitoring span. An absolute value of the k0 is less than or equal to an interval between a starting PDCCH time slot in the multi-slot PDCCH monitoring span and a PDCCH time slot where the DCI in the multi-slot PDCCH monitoring span is located.

The third determination module is configured to determine a time-frequency resource for PDSCH scheduled by each DCI based on the k0 corresponding to each DCI.

Embodiments of the present disclosure provide a network side device. The network side device includes a processor and a memory configured to store instructions executable by the processor. The processor is configured to execute the instructions in the memory to execute steps of the method for configuring downlink scheduling information.

Embodiments of the present disclosure provide user equipment. The user equipment includes a processor and a memory configured to store instructions executable by the processor.

The processor is configured to execute the instructions in the memory to execute steps of the method for determining downlink scheduling information.

Embodiments of the present disclosure provide a non-temporary computer-readable storage medium having executable instructions stored thereon. When executable instructions are executed by a processor, the method for configuring downlink scheduling information are caused to be implemented.

Embodiments of the present disclosure provide a non-temporary computer-readable storage medium having executable instructions stored thereon. When executable instructions are executed by a processor, the method for determining downlink scheduling information are caused to be implemented.

FIG. 13 is a block diagram of a device 1300 for configuring downlink control information according to exemplary embodiments. For example, the device 1300 can be provided as a server. Referring to FIG. 13, the device 1300 includes a processing component 1322, which further includes one or more processors, as well as memory resources represented by a memory 1332, for storing instructions that can be executed by the processing component 1322, such as application programs. The application programs stored in memory 1332 may include one or more modules corresponding to a set of instructions. In addition, the processing component 1322 is configured to execute instructions to implement the method for configuring downlink control information described above.

The device 1300 may also include a power component 1326 configured to perform power management of the device 1300, a wired or wireless network interface 1350 configured to connect the device 1300 to the network, and an input and output (I/O) interface 1358. The device 1300 can operate operating systems stored on the memory 1332, such as Windows Server™, Mac OS X™, Unix™, Linux™, FreeBSD™, or similar systems.

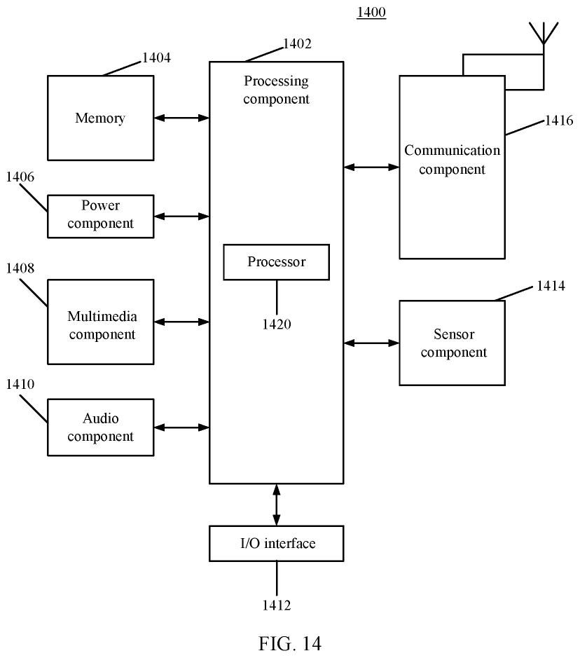

FIG. 14 is a block diagram of a device 1400 for determining downlink control information according to exemplary embodiments. For example, the device 1400 can be a mobile phone, a computer, a digital broadcasting user device, a messaging device, a game console, a tablet device, a medical device, a fitness device, a personal digital assistant, etc.

Referring to FIG. 14, device 1400 can include at least one of the following components: a processing component 1402, a memory 1404, a power component 1406, a multimedia component 1408, an audio component 1410, an input/output (I/O) interface 1412, a sensor component 1414, and a communication component 1416.

The processing component 1402 typically controls the overall operation of the device 1400, such as operations associated with display, telephone call, data communication, camera operation, and recording operations. The processing component 1402 may include one or more processors to execute instructions to complete all or part of the methods described above. In addition, the processing component 1402 may include one or more modules to facilitate interactions between the processing component 1402 and other components. For example, the processing component 1402 may include a multimedia module to facilitate interaction between the multimedia component 1408 and the processing component 1402.

The memory 1404 is configured to store various types of data to support operations in the device 1400. Examples of such data include instructions, contact data, phone book data, messages, pictures, videos, and the like for any application or method operating on the device 1400. The memory 1404 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 1406 provides power for various components of the device 1400. The power component 1406 may include a power management system, one or more power supplies, and other components associated with generating, managing, and distributing power for the device 1400.

The multimedia component 1408 includes a display screen providing an output interface between the device 1400 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 1408 includes a front camera and/or a rear camera. When the device 1400 is in operation mode, such as shooting mode or video mode, the front camera and/or rear camera can receive external multimedia data. Each front camera and rear camera can be a fixed optical lens system or have focal length and optical zoom capability.

The audio component 1410 is configured to output and/or input audio signals. For example, the audio component 1410 includes a microphone (MIC), which is configured to receive an external audio signal when the device 1400 is in an operation mode, such as a calling mode, a recording mode, and a voice recognition mode. The received audio signal may be further stored in memory 1404 or transmitted via communication component 1416. In some embodiments, the audio component 1410 also includes a speaker for outputting audio signals.

The I/O interface 1412 provides an interface between the processing component 1402 and peripheral interface modules, which can be a keyboard, click wheel, button, etc. These buttons may include, but are not limited to, the Home button, Volume button, Start button, and Lock button.

The sensor component 1414 includes one or more sensors for providing various aspects of condition evaluation for the device 1400. For example, the sensor component 1414 can detect an open/closed state of the device 1400, relative positioning of the components. The component is, for example, a display and a keypad of the device 1400. The sensor component 1414 can also detect changes in the position of the device 1400 or one component of the device 1400, presence or absence of the user's contact with the device 1400, orientation or acceleration/deceleration of the device 1400 and temperature change of the device 1400. The sensor component 1414 may include a proximity sensor configured to detect the presence of nearby objects without any physical contact. The sensor component 1414 may also include a light sensor, such as a CMOS or CCD image sensor, for use in imaging applications. In some embodiments, the sensor component 1414 may also include an acceleration sensor, a gyroscope sensor, a magnetic sensor, a pressure sensor, or a temperature sensor.

The communication component 1416 is configured to facilitate wired or wireless communication between the device 1400 and other devices. The device 1400 can access wireless networks based on communication standards, such as WiFi, 2G or 3G, or a combination thereof. In some embodiments, the communication component 1416 receives a broadcast signal or broadcast related information from an external broadcast management system via a broadcast channel. In some embodiments, the communication component 1416 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the device 1400 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some embodiments, a non-transitory computer-readable storage medium including instructions is also provided, such as a memory 1404 including instructions, which can be executed by a processor of the device 1400 to complete above methods. For example, the non-transitory computer-readable storage medium can be ROM, random access memory (RAM), CD-ROM, tapes, floppy disks, optical data storage devices, etc.

After considering the specification and practices of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure. The specification and embodiments are only considered exemplary, and the true scope and spirit of the present disclosure are defined by appended claims.

It should be understood that the present disclosure is not limited to the precise structure described above and shown in the drawings, and various modifications and changes can be made without departing from its scope. The scope of the present disclosure is limited only by the appended claims.

### INDUSTRIAL APPLICABILITY

By setting the k0 set to contain the negative integer less than 0, the DCI is enabled to schedule PDSCH resources located ahead of the time slot where this DCI is located, so as to make full use of PDSCH resources and achieve flexible scheduling.

1. A method for configuring downlink scheduling information, performed by a network side device, comprising:
setting a k0 set of Downlink Control Information (DCI) in a multi-slot Physical Uplink Shared Channel (PDCCH) monitoring span to contain at least one negative integer in the k0 set, wherein the k0 set comprises at least one k0, and the k0 is an interval between a time slot where the DCI in the multi-slot PDCCH monitoring span is located and a time slot where PDSCH scheduled by the DCI is located, and wherein the at least one k0 comprises the at least one negative integer.

2. The method for configuring downlink scheduling information according to claim 1, wherein setting the k0 set of the DCI in the multi-slot PDCCH monitoring span comprises:
sending a high-level signaling comprising the k0 set of the DCI in the multi-slot PDCCH monitoring span.

3. The method for configuring downlink scheduling information according to claim 1, wherein the k0 set contains all values between 1-Y and −1, and wherein Y is a number of PDCCH time slots comprised in the multi-slot PDCCH monitoring span.

4. The method for configuring downlink scheduling information according to claim 1, wherein the k0 set contains part of values between 1-Y and −1, and wherein Y is a number of PDCCH time slots comprised in the multi-slot PDCCH monitoring span.

5. The method for configuring downlink scheduling information according to claim 1, further comprising:
selecting one k0 from the k0 set as a k0 corresponding to one of the DCI in the multi-slot PDCCH monitoring span, wherein the k0 selected is a negative integer.

6. The method for configuring downlink scheduling information according to claim 5, wherein an absolute value of the k0 selected is less than or equal to an interval between a starting PDCCH time slot in the multi-slot PDCCH monitoring span and a PDCCH time slot where the DCI is located.

7. The method for configuring downlink scheduling information according to claim 5, further comprising:
sending the DCI in the multi-slot PDCCH monitoring span, wherein the DCI comprises the k0 corresponding to the DCI.

8. A method for determining downlink scheduling information, performed by user equipment, comprising:
determining a k0 set of Control Information (DCI) in a multi-slot Physical Uplink Shared Channel (PDCCH) monitoring span, wherein the k0 set comprises at least one k0, and the k0 is an interval between a time slot where the DCI in the multi-slot PDCCH monitoring span is located and a time slot where PDSCH scheduled by the DCI is located, and wherein the at least one k0 comprises at least one negative integer.

9. The method for determining downlink scheduling information according to claim 8, wherein determining the k0 set of the DCI in the multi-slot PDCCH monitoring span comprises:
receiving a high-level signaling comprising the k0 set of the DCI in the multi-slot PDCCH monitoring span.

10. The method for determining downlink scheduling information according to claim 8, wherein the k0 set contains all or part of values between 1-Y and −1, and wherein Y is a number of PDCCH time slots comprised in the multi-slot PDCCH monitoring span.

11. The method for determining downlink scheduling information according to claim 8, wherein
an absolute value of the k0 is less than or equal to an interval between a starting PDCCH time slot in the multi-slot PDCCH monitoring span and a PDCCH time slot where the DCI is located.

12-22. (canceled)

23. A network side device, comprising:
a processor; and
a memory configured to store instructions executable by the processor;
wherein the processor is configured to set a k0 set of Control Information (DCI) in a multi-slot Physical Uplink Shared Channel (PDCCH) monitoring span to contain at least one negative integer in the k0 set, wherein the k0 set comprises at least one k0, and the k0 is an interval between a time slot where the DCI in the multi-slot PDCCH monitoring span is located and a time slot where PDSCH scheduled by the DCI is located, and wherein the at least one k0 comprises the at least one negative integer.

24. User equipment, comprising:
a processor; and
a memory configured to store instructions executable by the processor;
wherein the processor is configured to execute the instructions in the memory to implement steps of the method for determining downlink scheduling information according to claim 8.

25. (canceled)

26. The method for determining downlink scheduling information according to claim 8, further comprising:
determining a k0 corresponding to each DCI in the multi-slot PDCCH monitoring span.

27. The method for determining downlink scheduling information according to claim 8, further comprising:
determining a time-frequency resource for PDSCH scheduled by each DCI based on the k0 corresponding to each DCI.

28. The network side device according to claim 23, wherein the processor is further configured to send a high-level signaling comprising the k0 set of the DCI in the multi-slot PDCCH monitoring span.

29. The network side device according to claim 23, wherein the k0 set contains all or part of values between 1-Y and −1, and wherein Y is a number of PDCCH time slots comprised in the multi-slot PDCCH monitoring span.

30. The network side device according to claim 23, wherein the processor is further configured to select one k0 from the k0 set as a k0 corresponding to one of the DCI in the multi-slot PDCCH monitoring span, wherein the k0 selected is a negative integer.

31. The network side device according to claim 30, wherein an absolute value of the k0 selected is less than or equal to an interval between a starting PDCCH time slot in the multi-slot PDCCH monitoring span and a PDCCH time slot where the DCI is located.

32. The network side device according to claim 30, wherein the processor is further configured to send the DCI in the multi-slot PDCCH monitoring span, wherein the DCI comprises the k0 corresponding to the DCI.
